(19) United States
(12) Patent Application Publication
(10) Pub. No.: US 2018/0228162 A1
(43) Pub. Date: Aug. 16, 2018

(54) HONEY BEE SWARM LURE

(71) Applicant: Roger Graham, Bargersville, IN (US)

(72) Inventor: Roger Graham, Bargersville, IN (US)

(21) Appl. No.: 15/429,528

(22) Filed: Feb. 10, 2017

(51) Int. Cl. A01N 63/00; A01N 25/08; A01N 25/30; A01N 65/44; A01N 35/02; A01N 31/02; B65D 41/04; B65D 35/44; B65D 83/00; A01K 57/00

(52) U.S. Cl. CPC A01N 63/00; A01N 25/08; A01N 25/30; A01N 65/44; A01K 57/00; A01N 31/02; B65D 41/04; B65D 35/44; B65D 83/0011; A01N 35/02

(57) ABSTRACT

A biodegradable swarm lure formulation effective to provide for continuous release of one or more queen bee pheromone from a carrier over an extended period of time to effectively attract members of target honey bee populations includes a tincture of queen bee and a carrier effective to provide a substantially continuous release of the at least one queen bee pheromone over an extended period of time. One swarm lure formulation includes a tincture of queen bee, a biodegradable wax carrier, an emulsifier, a citral, a geraniol and a lemon grass oil. A swarm lure formulation dispenser can be used to apply a quantity of the swarm lure formulation to a swarm trap or hive to attract honey bees to the swarm trap or hive to encourage creation of a new colony of honey bees in the swarm trap or hive.

### TECHNICAL FIELD

The present disclosure generally relates to an insect lure formulations and related methods and, more particularly, relates to an insect lure that attracts a swarm of honey bees.

### BACKGROUND

Honey bees are frequently maintained and housed by an apiarist in order to harvest the honey, beeswax, and other byproducts generated by a hive of honey bees. The term “honey bee” is used herein to indicate all insects belonging to the genus Apis, examples of which include Apis nearctica, Apis andreniformis, Apis florea, Apis dorsata, Apis cerana, Apis koschevnikovi, Apis mellifera and Apis nigrocincta. A typical honey bee colony or hive consists of a queen bee, worker bees, and drones. Under certain conditions, such as overcrowding the current hive, a colony may swarm to identify a better location for the colony. One way for an apiarist to obtain a colony of honey bees is to attract a swarm to a swarm trap. One example of a swarm trap is a box-like structure that has at least one opening for the honey bees to enter. The swarm trap ideally has interior dimensions that are appealing to the colony. If a swarm identifies a swarm trap that is appealing, at least a portion of the original colony will move to the swarm trap.

One way honey bees communicate is by utilizing pheromones to inform other honey bees where to go. One method used to catch a swarm of honeybees includes utilizing pheromones in the swarm trap to increase the chances of attracting a swarm. Honey bees often interpret certain pheromones as an indication that other honey bees found that location favorable. Accordingly, a lure is often placed in a swarm trap to utilize pheromones to attract a swarm of honey bees.

There remains a need for further development in the field of honey bee swarm lures. The present disclosure addresses this need.

### SUMMARY

The present disclosure relates to methods, systems and products involving honey bee swarm lures operable to attract a swarm of honey bees.

In accordance with one aspect of the present disclosure, a swarm lure formulation is provided that includes a tincture of queen bee, a waxy carrier and an emulsifier, in which the tincture of queen bee and the emulsifier are dispersed in the wax. In one embodiment, the tincture of queen bee includes a first pheromone extracted from at least one virgin queen bee and a second pheromone extracted from at least one mated and laying queen bee. In another embodiment, the waxy carrier comprises beeswax. In yet another embodiment, the emulsifier comprises polysorbate 80. In still another embodiment, the swami lure formulation includes at least one additional ingredient selected from the group consisting of a plant terpenoid and lemon grass oil. In still yet another embodiment, the swarm lure formulation includes at least one additional ingredient selected from the group consisting of a lemon grass oil, a citral and a geraniol. In one preferred embodiment, the formulation includes a tincture of queen bee, a waxy carrier, an emulsifier, a lemon grass oil, a citral and a geraniol. In another preferred embodiment, the formulation comprises tincture of queen bee in an amount from about 2% to about 6% by weight of the formulation; a biodegradable wax carrier in an amount of from about 58% to about 82% by weight of the formulation; an emulsifier in an amount of from about 1% to about 6%, by weight of the formulation; a citral in an amount of from about 5% to about 10% by weight of the formulation; a geraniol in an amount of from about 5% to about 10% by weight of the formulation; and a lemon grass oil in an amount of from about 5% to about 10% by weight of the formulation.

In another aspect, the present disclosure provides a method for making a swarm lure product that includes (i) heating a first quantity of a waxy carrier to a melting point temperature of the waxy carrier to provide a molten wax carrier; (ii) mixing into the molten wax carrier an emulsifier, a tincture of queen bee and optionally additional ingredients to form a liquid swarm lure formulation; (iii) loading the liquid swarm lure formulation into a dispenser; (iv) cooling the liquid swarm lure formulation to form a solidified swami lure formulation; and (v) sealing the dispenser with a cap. In one embodiment of the method, the tincture of queen bee comprises a first pheromone extracted from at least one virgin queen bee and a second pheromone extracted from at least one mated and laying queen bee. In another embodiment of the method, the waxy carrier comprises beeswax. In yet another embodiment of the method, the emulsifier comprises polysorbate 80. In still another embodiment, the method further includes mixing into the molten wax carrier at least one additional ingredient selected from the group consisting of a plant terpenoid and lemon grass oil. In still yet another embodiment, the method further comprising mixing into the molten wax carrier at least one member selected from the group consisting of a lemon grass oil, a citral and a geraniol. In another embodiment, the method further includes mixing into the molten wax carrier a lemon grass oil, a citral and a geraniol. In still another embodiment of the method, the formulation comprises tincture of queen bee in an amount from about 2% to about 6% by weight of the formulation; a biodegradable wax carrier in an amount of from about 58% to about 82% by weight of the formulation; an emulsifier in an amount of from about 1% to about 6%, by weight of the formulation; citral in an amount of from about 5% to about 10% by weight of the formulation; geraniol in an amount of from about 5% to about 10% by weight of the formulation; and lemon grass oil in an amount of from about 5% to about 10% by weight of the formulation. In yet another embodiment of the method, the dispenser comprises a cylindrical tube and an axially movable component that selectively repositions the solidified swarm lure formulation relative to an opening formed in the cylindrical tube. In still yet another embodiment of the method, the dispenser comprises a squeezable tube with an opening, the dispenser operable to dispense the solidified swarm lure formulation through the opening.

In yet another aspect of the disclosure, there is provided a method of luring honey bees to a swarm trap that includes (i) providing a swarm lure formulation including a tincture of queen bee, a waxy carrier and an emulsifier, wherein the tincture of queen bee and the emulsifier are dispersed in the waxy carrier, and (ii) depositing a quantity of the swarm lure formulation onto the swarm trap. In one embodiment of the method, the swarm lure formulation is contained within a dispenser that comprises a cylindrical tube and an axially movable component that selectively repositions the solidified swarm lure formulation relative to an opening formed in the cylindrical tube. In another embodiment, the axially movable component is repositionable by rotating a rotatable component of the dispenser.

Still other features, characteristics, objects and benefits of the disclosure will become apparent from the following description.

### BRIEF DESCRIPTION OF THE FIGURES

FIG. 1 illustrates a flowchart of one method for making a swarm lure formulation.

FIG. 2 illustrates a rollout dispenser embodiment.

FIG. 3 illustrates a squeeze dispenser embodiment.

### DETAILED DESCRIPTION OF ILLUSTRATED EMBODIMENTS

For the purposes of promoting an understanding of the principles of the invention, reference will now be made to certain embodiments and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Unless defined otherwise, all terms used herein have the same meaning as commonly understood by one of ordinary skill in the art to which this application pertains. Moreover, it should be understood that when certain values and ranges are recited herein in connection with various embodiments of the present disclosure, all values and ranges which fall between such listed values and ranges are intended to be encompassed by the present disclosure unless explicitly stated otherwise. Although specific methods and materials are described herein with respect to certain exemplary aspects of the present disclosure, it should be understood and appreciated that other methods and materials similar or equivalent to those described herein can be used in the practice of the present invention without straying from the invention's intended scope.

In one aspect of the present disclosure, there is provided a biodegradable swarm lure formulation that is effective to provide for continuous release of one or more queen bee pheromone from a carrier over an extended period of time to effectively attract members of target honey bee populations. The swarm lure formulation can have a variety of forms, including solid forms and sprayable forms. In one embodiment, a swarm lure formulation includes a combination of tincture of queen bee, which includes at least one queen bee pheromone, and a carrier effective to provide a substantially continuous release of the at least one queen bee pheromone over an extended period of time. In one embodiment, the extended period of time is a period of at least one week. In another embodiment, the extended period of time is a period of at least two weeks. In yet another embodiment, the extended period of time is a period of at least three weeks.

As used herein, the term “tincture of queen bee” refers to an alcoholic extract of queen bee pheromones. In one embodiment, the tincture of queen bee comprises an extract of mated and laying queen bees. In another embodiment, the tincture of queen bee comprises an extract of virgin queen bees. In yet another embodiment, the tincture of queen bee comprises an extract of a combination of mated and laying queen bees and virgin queen bees. A particularly preferred tincture of queen bee is made by mincing a combination of at least one mated and laying queen bee and at least one virgin queen bee and seeping the minced bees in an alcohol, such as, for example, isopropyl alcohol, for a period of time. In one embodiment the ratio of laying queen bees to virgin queen bees in the combination is from about 1:5 to about 5:1. In another embodiment, the ratio is from about 1:3 to 3:1. In yet another embodiment, the ratio is 1 laying queen bee to 1 virgin queen bee. In one embodiment, the period of time that the minced bees are seeped to extract pheromones is a period of from about 1 month to about 18 months. In another embodiment, the minced bees are seeped for a period of from about 3 months to about 15 months. In yet another embodiment, the period is from about 6 months to about 12 months.

A wide variety of carriers can be used as would occur to a person of ordinary skill in the art. In one embodiment, the carrier is a waxy biodegradable carrier that is effective to adhere to a surface of a desired structure to which attraction of a swarm of honey bees is desired. In another embodiment, the carrier is a liquid carrier. In still other embodiments, the carrier is a porous polymer material, an adsorbent or adsorbent textile material made of natural or synthetic fibers or the like. As used herein, the term “polymer” generally includes, but is not limited to, hompolymers, copolymers, such as, for example, block, graft, random and alternating copolymers, terpolymers, etc., and blends and modifications thereof. The textile material can take a wide variety of forms, provided that it is operable to absorb, adsorb or otherwise become impregnated with the tincture of queen bee.

In a particularly preferred embodiment, the carrier is a biodegradable waxy carrier. The term “waxy carrier” refers to a class of chemical compounds that are plastic (malleable) near ambient temperatures. Characteristically, waxes melt above about 45° C. (113° F.) to give a low viscosity liquid. Waxes are insoluble in water but soluble in organic, nonpolar solvents. All waxes are organic compounds, both synthetic and naturally occurring. Examples of suitable waxy carriers include, without limitation, natural wax (e.g., beeswax or lanolin), vegetable wax (e.g., Carnauba), mineral wax (e.g., montan or paraffin) and synthetic wax (e.g., polyethylene (polar or nonpolar), polypropylene, Fischer-Tropsch, or polybutene). In one embodiment, the biodegradable wax carrier is a wax selected from the group consisting of beeswax, lanolin, shellac wax, carnauba wax, fruit wax (such as, for example, bayberry or sugar cane wax), candelilla wax, hydrocarbon based waxes such as paraffin wax and other waxes such as, for example, microcrystalline, ozocerite, ceresin, montan, vegetable based waxes such as soy wax, or combinations thereof. In a preferred embodiment the waxy carrier comprises a natural wax. In another preferred embodiment the waxy carrier comprises beeswax. Beeswax is easy to handle, has a practical melting point for uses as described herein and is relatively inexpensive. Beeswax has a melting point of about 64° C. (147° F.) and is miscible with tincture of queen bee when molten. Beeswax also exhibits good continuous release characteristics for the tincture of queen bee in release rate ranges suitable for the uses described herein. In alternate embodiments, formulations can include beeswax alone (i.e., with beeswax as the sole biodegradable wax carrier) or in combination with other types of biodegradable carriers, or in combination with a variety of additives, as discussed further below.

In addition to the ingredients discussed above, a variety of other ingredients can be incorporated into the swarm lure formulations as optional additives. The additives can be included, for example, in a pre-formulated carrier mixture that includes the biodegradable wax carrier and the additives, which can then he blended with the tincture of queen bee to provide a swarm lure formulation. A pre-formulated carrier mixture can be made by combining the carrier mixture and selected additives in predetermined ratios in accordance with the present disclosure. In one embodiment, an additive comprises an ingredient that either affects the release rate of one or more queen bee pheromone from the formulation or otherwise affects the attractant properties and/or physical properties of the formulation and/or protect the formulation from weather conditions, for example. Such optional additives include, among others, plant terpenoids, lemon grass oil, emulsifiers, plasticizers, volatility suppressants, antioxidants and/or lipids.

In one embodiment, the formulation includes at least one plant terpenoid. Examples of plant terpenoids contemplated by this disclosure include citral and geraniol. The geraniol may be derived, for example from rose oil, palmarosa oil, and/or citronella oil. In one embodiment, the geraniol may be derived from geranium, lemon, or other essential oils. It is to be understood, however, that the present disclosure is not limited to these representative plant terpenoids, and that other plant terpenoids are also contemplated.

In another embodiment, the formulation includes lemon grass oil.

In yet another embodiment, the formulation includes at least one emulsifier to impart or improve emulsification properties of the formulation. Examples of emulsifiers that can be used in alternate embodiments include lecithin and modified lecithins, mono- and diglycerides, sorbitan monopaltnitate, sorbitan monooleate, sorbitan monolaurate, polyoxyethylene-sorbitan monooleate, fatty acids, lipids, and combinations thereof. Other sorbitan fatty acid esters that may be used include sorbitan monostearate, sorbitan tristearate, sorbitan sesquioleate, sorbitan trioleate. In one embodiment, the emulsifier Polysorbate 80 is included in a formulation.

Plasticizers can affect physical properties of a formulation described herein, such as, for example, to extend its resistance to degradation in the field. In one embodiment, the swarm lure formulation includes a plasticizer. Examples of suitable plasticizers include glycerin and soy oil. In one embodiment, a plasticizer is present in the formulation in an amount of up to about 40% by weight of the total formulation, or any range within said range. For example, in another embodiment, the formulation includes a plasticizer in an amount from about 1% to about 40% by weight of the total formulation. In yet another embodiment, the formulation includes a plasticizer in an amount from about 1% to about 25% by weight of the total formulation. In still another embodiment, the formulation includes a plasticizer in an amount from about 1% to about 15% by weight of the total formulation.

In another embodiment, the formulation includes at least one antioxidant that is operable to protect the formulation and/or one or more of its ingredients from degradation. Examples of suitable antioxidants for inclusion include, without limitation, vitamin E, BHA (butylated hydroxyanisole) and BHT (butylated hydroxytoluene). In one embodiment, at least one antioxidant is present in the formulation in an amount of up to about 3% by weight of the total formulation, or any range within said range. For example, in another embodiment, the formulation includes at least one antioxidant in an amount from about 0.1% to about 3% by weight of the total formulation. In yet another embodiment, the formulation includes at least one antioxidant in an amount from about 0.1% to about 2% by weight of the total formulation. In still another embodiment, the formulation includes at least one antioxidant in an amount from about 0.1% to about 1% by weight of the total formulation.

Other compounds and materials may also be included in formulations described herein provided they do not substantially interfere with the attractant activity of the formulation. Whether or not an additive substantially interferes with the attractant activity can be determined by standard test formats, involving direct comparisons of efficacy of a given formulation without an added compound or material and a formulation that is otherwise the same, but with the added compound or material.

In one embodiment, the formulation includes tincture of queen bee in an amount from about 0.5% to about 15% by weight of the total formulation, or any weight range within said weight range; a biodegradable wax carrier in an amount of from about 30% to about 98%, by weight of the total formulation, or any weight range within said weight range; an emulsifier in an amount of from about 0.5% to about 10%, by weight of the total formulation, or any weight range within said weight range, and one or more additional additive in a total amount of from 0% to about 40% by weight of the total formulation, or any weight range within said weight range. As used herein, the term “total formulation” refers to all of the ingredients in a given formulation, excluding water, which may be present in certain embodiments, as discussed further below. This term is used in this manner with the understanding that the amount of water included in an emulsion embodiment described herein can vary significantly, which can have an effect on the viscosity of the formulation and the drying time of a coating or dollop of the formulation after application to a locus in the field, but does not otherwise affect the properties or effectiveness of a given formulation. Therefore the values provided in this disclosure as weight percent of a total formulation refer only to the non-water ingredients of the subject formulation. In one embodiment, the one or more additional additive comprises one or more plant terpenoid, a lemon grass oil or combinations thereof. In a preferred embodiment, the one or more additional additive comprises citral, geraniol and lemon grass oil. In another preferred embodiment, the emulsifier comprises Polysorbate 80.

In another embodiment, the formulation includes tincture of queen bee in an amount from about 1% to about 10% by weight of the total formulation, or any weight range within said weight range; a biodegradable wax carrier in an amount of from about 40% to about 95%, by weight of the total formulation, or any weight range within said weight range; an emulsifier in an amount of from about 0.5% to about 10%, by weight of the total formulation, or any weight range within said weight range, and one or more additional additive in a total amount of from about 5% to about 40% by weight of the total formulation, or any weight range within said weight range. In yet another embodiment, the formulation includes tincture of queen bee in an amount from about 2% to about 6% by weight of the total formulation, or any weight range within said weight range; a biodegradable wax carrier in an amount of from about 58% to about 82%, by weight of the total formulation, or any weight range within said weight range; an emulsifier in an amount of from about 1% to about 6%, by weight of the total formulation, or any weight range within said weight range, and one or more additional additive in a total amount of from about 15% to about 30% by weight of the total formulation, or any weight range within said weight range.

In one embodiment, the one or more additional additive comprises one or more of citral, geraniol and lemon grass oil. In another embodiment the formulation includes tincture of queen bee in an amount from about 2% to about 6% by weight of the total formulation, or any weight range within said weight range; a biodegradable wax carrier in an amount of from about 58% to about 82%, by weight of the total formulation, or any weight range within said weight range; an emulsifier in an amount of from about 1% to about 6%, by weight of the total formulation, or any weight range within said weight range; citral in an amount of from about 5% to about 10% by weight of the total formulation, or any weight range within said weight range; geraniol in an amount of from about 5% to about 10% by weight of the total formulation and lemon grass oil in an amount of from about 5% to about 10% by weight of the total formulation.

A person of ordinary skill in the art will appreciate from the present disclosure that the proportions of the components or ingredients of the swami lure formulations disclosed herein can be varied beyond the example proportions set forth herein and that such variations can impact the length of time that the formulation will release pheromones, the rate at which pheromones will be released by the formulation in the field, the amount of the formulation required to produce a desired attractive effect on honey bees and the like.

The components of formulations described herein can be mixed in any manner known in the art. For example, a formulation can be prepared by heating a predetermined amount of the biodegradable wax, e.g. beeswax, to soften or melt the wax and then mix the wax with a predetermined amount of tincture of queen bee and other ingredients to be included in a particular formulation. As will be appreciated, each “predetermined amount” is based upon the desired ratios of the various components in the final formulation. Additional ingredients (i.e., additives) can also be added in predetermined amounts at any stage of mixing. The ratios of the ingredients are selected based on the intended properties of the formulation, the intended application method, and other considerations.

In one manner of preparing the formulation, the wax is first heated to a melting point temperature, typically from about 45° C. to about 80° C., depending on the type of the wax. In an embodiment utilizing beeswax, the wax is preferably heated to a temperature of from about 62° C. to about 64° C. The tincture of queen bee, and optionally additional ingredients, alone or in combination, are then added directly to the molten wax carrier and the mixture is stirred. In one manner of making the formulation, the additional ingredients are added to the molten wax carrier along with the tincture of queen bee to form the final formulation. In another manner of making the formulation, a pre-formulated carrier mixture including a biodegradable wax carrier and optional additives is first made (i.e., as described above) or otherwise provided, and then the pre-formulated carrier mixture is heated and mixed with the tincture of queen bee to provide a swarm lure formulation. The formulation may be stirred or emulsified mechanically. The formulation is then formed into a desired shape or placed in a desired delivery package and then cooled and stored.

The rate at which one or more queen bee pheromone are released from the formulation in use (referred to as the “release rate”) can be adjusted by inclusion of one or more of the optional additives described above in the formulation. In one manner of employing a formulation as described herein, the formulation is applied directly to or on the surfaces to be treated, such as in or on a honey bee swarm trap or hive. The formulation can be applied to form a dollop or coating on the treated surface from which the one or more queen bee pheromone is released in a substantially continuous manner over an extended period of time. In other embodiments, the formulation can be formed into a solid shape, such as, for example, a disk, granule or powder, that is placed in the honey bee swarm trap or hive to continuously release the one or more queen bee pheromone from the solid biodegradable wax carrier matrix over an extended period of time.

Using a variety of additives for control of the release rate from the biodegradable wax carrier, the formulation can be custom designed. In one embodiment, the amount of the tincture of queen bee to be included in the formulation is calculated to be sufficient to operate as an attractant for honey bees for a predetermined period of time. The release rate of the one or more queen bee pheromones from the biodegradable wax carrier can be affected, for example, by the physical properties of the biodegradable wax carrier, by the respective concentrations of the biodegradable wax carrier, the tincture of queen bee and other optional ingredients, and their ratios, by the physical properties and characteristics of the overall formulation, by the presence or absence of one or more optional additives, by the additives' type and concentration, by the application conditions, by the weather and by the season. For example, the thickness of the dollop or coating layer also can affect the release rate. For example, a slower release rate can be achieved when the formulation is applied as a thicker dollop or coating, by including certain additives in the formulation, by including lower concentrations of the tincture of queen bee, or by providing thicker wax disks or bigger granules. Conversely, a faster release rate can be achieved with formulations including only a wax carrier without additives, having a higher concentration of the tincture of queen bee, and applying the formulation as a thin coating, a larger area disk, or smaller granules.

With regard to the effect of additives on the release rate, the release rate of the one or more queen bee pheromones can also be affected by the presence of certain additives, such as antioxidants and/or volatility suppressants, incorporated into the biodegradable wax carrier together with the tincture of queen bee. Volatility suppressants decrease the release rate of the attractants. Antioxidants such as vitamin E increase the stability of the attractants and slow their degradation and oxidation. Consequently, a formulation embodiment including these additives can be more economical and can have an improved longevity over embodiments in which the attractants are unprotected and may be subjected to oxidation.

All the above-listed parameters are variable and their variation provides formulations having different release rates of one or more queen bee pheromone and different useful lives (also referred to as “longevities,” which refers to the period of time during which the formulation continues to release effective amounts of one or more queen bee pheromones). All variations of these properties are intended to be within the scope of the present disclosure.

One embodiment of a method for making a swarm lure formulation as disclosed herein includes (i) heating a wax to a temperature above its melting temperature to provide a liquid wax, (ii) mixing a tincture of queen bee with the liquid wax to provide a mixture, and (iii) cooling the mixture to a temperature below the melting temperature of the wax. In another embodiment, the method further includes positioning the mixture in a dispenser. In alternate embodiments, a fibrous substrate can be impregnated with the mixture or with the tincture of queen bee and positioned in a package before or after the fibrous substrate is impregnated. In one embodiment, the method further includes sealing the package.

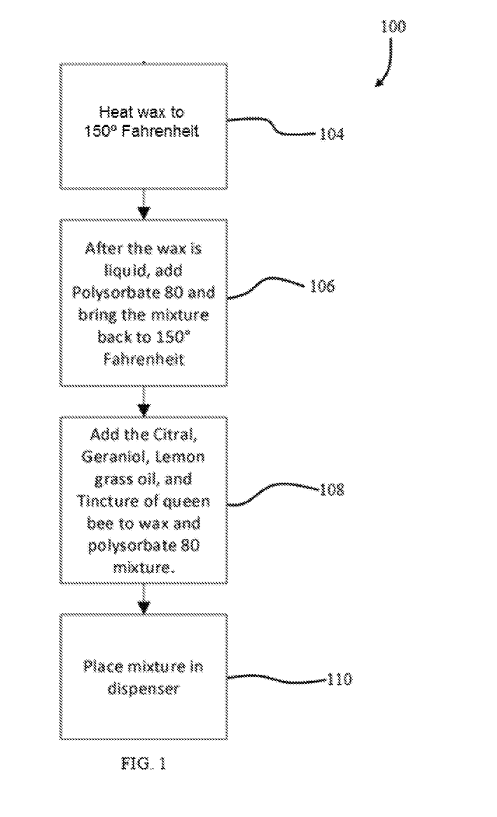

A representative method 100 of making a swarm lure formulation is illustrated by FIG. 1. More specifically, FIG. 1 illustrates a method of making a swarm lure formulation according to one embodiment of the present disclosure that includes tincture of queen bee, beeswax, citral, geraniol, lemon grass oil and polysorbate 80.

In the method embodiment illustrated in FIG. 1, a double boiler, or any other appropriate heating mechanism, may be used to heat the beeswax to a melting point. In a first step 104 of this method embodiment, beeswax is heated to a temperature of 150° Fahrenheit. It is to be understood that this disclosure is not limited to precisely that temperature. In other embodiments the beeswax may be heated to any temperature that causes the beeswax to melt. In one embodiment, an amount of beeswax is heated in step 104 that is sufficient to make one dose of the swarm lure. Alternatively, an amount of beeswax is heated that is sufficient to make several doses of the swarm lure. As used herein the, term “dose” refers to an amount to be applied to a single locus, such as a swarm trap or hive, at a single time.

In step 106, polysorbate 80 is added to the liquid beeswax. In one embodiment, the polysorbate 80 is added in an amount such that the ratio of beeswax to polysorbate 80 is from about 5:1 to about 100:1, by weight. In another embodiment, the polysorbate 80 is added in an amount such that the ratio of beeswax to polysorbate 80 is from about 10:1 to about 80:1, by weight. In yet another embodiment, the polysorbate 80 is added in an amount such that the ratio of beeswax to polysorbate 80 is from about 10:11 to about 40:1, by weight. After the polysorbate 80 is added to the beeswax, the mixture is maintained at, or heated back to, 150° Fahrenheit. While 150° Fahrenheit is specifically described, any temperature that allows the mixture to maintain liquid form is appropriate and considered herein.

Next, in step 108, citral, geraniol, lemon grass oil and tincture of queen bee are added to the beeswax and polysorbate 80 mixture and thoroughly mixed to provide a liquid formulation. The citral, geraniol, lemon grass oil and tincture of queen bee are added in step 108 in relative amounts desired in accordance with the present disclosure.

After the liquid formulation is thoroughly mixed, the liquid formulation is placed in a dispenser in step 110. If desired, the liquid formulation may be allowed to cool to a degree necessary to change to a paste form before being placed in a dispenser. The swarm lure may remain in paste form under proper temperature conditions while in the dispenser.

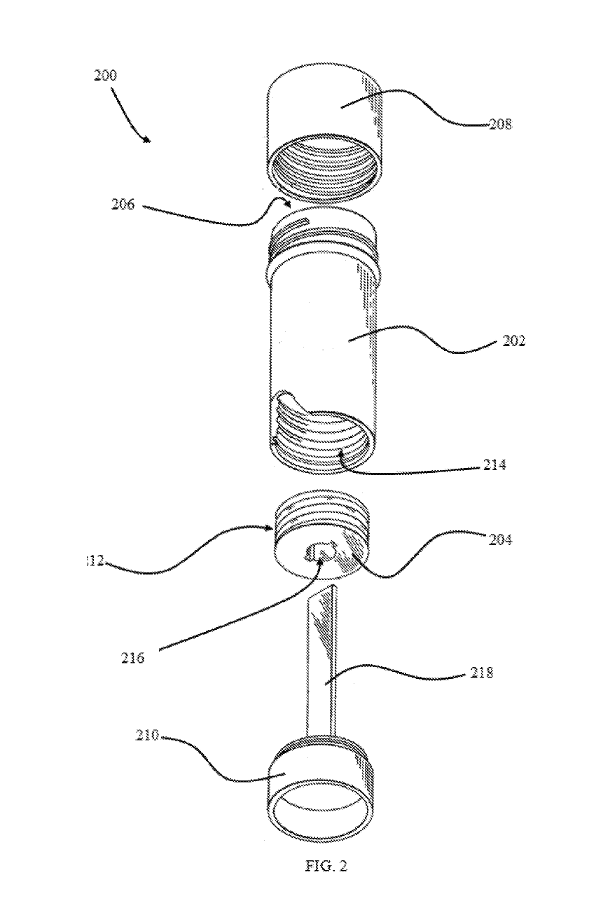

A wide variety of dispensers are contemplated by the present disclosure. The dispenser may be any type of dispenser capable of containing the swarm lure. In one nonexclusive example, illustrated in FIG. 2, the dispenser is in the form of rollout container 200 of a type commonly used, for example, as a dispenser for lip balm products. Rollout container 200 includes cylindrical tube 202, axially movable component 204 and rotatable component 210. Cylindrical tube 202 includes threaded inner surface 214 and defines dispensing opening 206. Axially movable component 204 has a threaded outer surface 212 that corresponds with threaded inner surface 214 of cylindrical tube 202 and is positioned within cylindrical tube 202 at a location distal to opening 206. Axially movable bottom component 204 defines a rectangular through-hole 216 positioned through a substantially central portion of axially movable component 204. Rotatable component 210 includes a rectangular shaft 218 extending away from the rotatable component 210 and towards the opening in the cylindrical chamber 202 when axially movable component 204 coupled to cylindrical tube 201. Rectangular shaft 218 is sized to correspond with the rectangular through-hole 216 of the axially movable component 204. In this configuration, axially movable component 204 is threaded into cylindrical tube 202 via threaded outer surface 212 and threaded inner surface 214 and axially movable component 204 is rotatingly coupled to cylindrical tube 202 with rectangular shaft 218 extending through rectangular through-hole 216 of axially movable component 204. When rotatable component 210 is rotated relative to cylindrical tube 202, rectangular shaft 218 positioned in rectangular through-hole 216 drives rotation of axially movable component 204 relative to cylindrical tube 202. Rotation of axially movable component 204 causes axially movable component 204 to be axially displaced relative to opening 206 depending on the direction of rotation.

To use rollout container 200 to deliver a swarm lure formulation as disclosed herein, the swarm lure formulation is deposited within cylindrical tube 202. Once the swarm lure formulation has been deposited within cylindrical tube 202, cap 208 may be positioned over the opening 206 to substantially seal the swarm lure formulation within cylindrical tube 202. To apply the swarm lure to a surface of a swarm trap, hive or other locus, the user may remove cap 208 and articulate rotatable component 210 in a first direction to advance axially movable component 204 toward opening 206, thereby causing at least a portion of the swarm lure to pass through opening 206 and therefore become exposed for application to a surface of a swarm trap, hive or other locus.

While a particular example of a rollout tube 200 is illustrated in FIG. 2 and described above, this disclosure also contemplates alternative rollout tube designs. For example, in another embodiment axially movable component 204 may be threaded along a center through-hole. In this embodiment, the rotatable component 210 has a corresponding threaded shaft. When rotatable component 210 is rotated relative to the cylindrical tube 202 in such an embodiment, the threaded shaft rotates and causes axially movable component 204 to move towards, or away from, the opening. Moreover, while a cylindrical tube 202 has been shown and described herein, this disclosure also considers a rollout tube with a chamber in any shape and is not limited to cylindrical chambers. Rather, this disclosure also considers chambers for a rollout tube that have a rectangular, square, triangular, and the like shaped cross-section. A person skilled in the relevant art understands the many different designs that provide a rollout tube dispenser and this disclosure is not limited to any particular design.

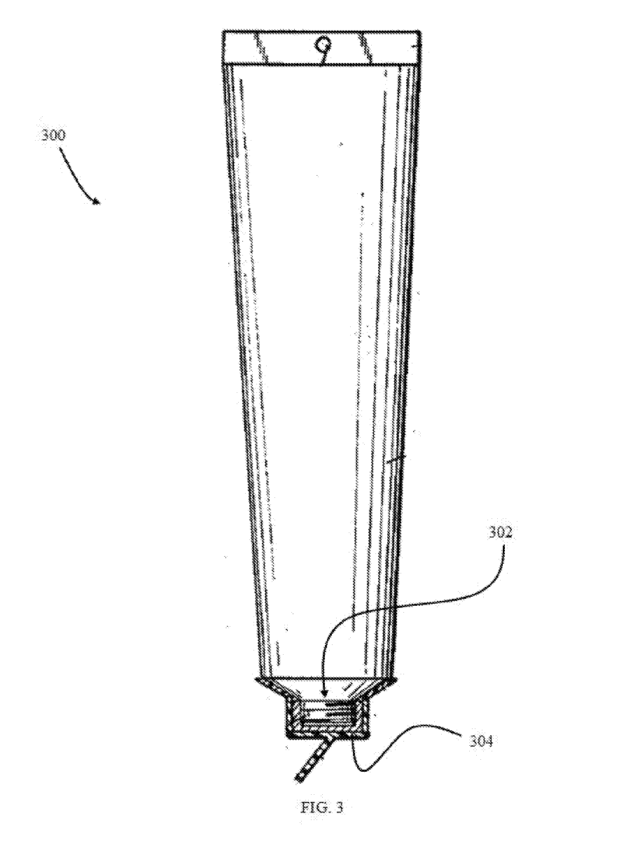

In another embodiment illustrated in FIG. 3, the swarm lure is deposited in a squeezable tube 300 having an opening 302. In this embodiment, squeezable tube 300 has only one opening 302 and is formed of a material that is pliable. The swarm lure formulation may be inserted into squeezable tube 300 through opening 302 and cap 304 may be coupled over opening 302. Cap 304 is operable to substantially seal the swarm lure formulation within the squeezable tube 300. If a user desires to apply the swarm lure formulation, the user may remove cap 304 and apply force to squeezable tube 300 to force a quantity of the swarm lure formulation out of the opening 302. Cap 304 may be coupled to squeezable tube 300 through any number of known coupling mechanisms. In one embodiment, cap 304 is threadably coupled to squeezable tube 300 about the opening 302 to thereby seal the opening 302 when cap 304 is positioned thereon. In another embodiment, cap 304 is configured to be press-fit onto squeezable tube 300 to seal opening 302. A person skilled in the relevant art understands that there are a wide variety of ways that a squeezable tube may define and cap an opening, and this disclosure is not limited to the particular design example depicted in FIG. 3. Moreover, while specific types of dispensers are described herein, this disclosure is not limited to any the specific types of dispensers shown and described. Rather, any dispenser that is operable to selectively contain and dispense a swarm lure formulation is contemplated by this disclosure. Other examples of dispensers that are contemplated, for example, include grease pump type devices and caulk gun type devices, which can be readily adapted for delivery of dollops of a swarm lure formulation as described herein. When using a delivery device of the caulking gun type or grease pump type, the formulation can be packaged and provided in tubes configured to fit with the delivery device.

In other embodiments, swarm lure formulations are formed to be used without a dispenser. For example, in other embodiments swarm lure formulations including a biodegradable wax carrier comprising beeswax are formulated as solid blocks, such as disk-shaped blocks, or as solid granules or powders, which can be placed on or in swarm traps or hives.

Alternatively, formulations including a biodegradable wax carrier comprising beeswax can be applied from a sprayer as an aqueous emulsion that adheres to a desired surface, releases queen bee pheromones for an extended period of time and biodegrades over time. The biodegradable wax carrier in one embodiment comprises a compound or compounds operable to form an aqueous sprayable emulsion at ambient temperatures of a given treatment locus. In an aqueous sprayable emulsion embodiment, the aqueous emulsion is operable to dry (i.e., upon evaporation of the water from the emulsion) after being placed in ambient conditions to form a coating with the tincture of queen bee dispersed and releasably contained in the biodegradable wax carrier matrix. “Spraying” of an aqueous emulsion refers to application of the formulation by spraying, squirting or splitting. In one embodiment, a formulation comprises a sprayable wax emulsion having a viscosity appropriate for delivery through an atomizing spray delivery device.

After a swarm lure formulation in the form of an aqueous suspension or emulsion is applied to a treated surface (also referred to as a sprayed surface), the water from the emulsion evaporates, resulting in an adherent dried coating. The at least one queen bee pheromone, and any additional attractants optionally included in the formulation, are continuously released from the coating over an extended period of time either by diffusing to the surface of the dried coating where it evaporates, or by degradation or erosion of the coating. The attractants are released at a rate sufficient to attract members of the targeted honey bees.

In another aspect of the present disclosure, various methods for attracting a swarm of honey bees are contemplated. In one embodiment, the swarm lure formulation is utilized along with a swarm trap to attract a swarm of honey bees. More specifically, a swarm lure formulation described herein is applied to a suitable swarm trap to encourage honey bees to colonize the swarm trap. In this embodiment, the user may provide a suitable swarm trap of the proper size to accommodate a swarm of honey bees. The user may then apply a quantity of the swarm lure formulation to an interior portion of the swarm trap. For example, in an embodiment in which a swarm lure formulation is contained within a rollout dispenser such as dispenser 200 depicted in FIG. 2, the user may expose a portion of the swarm lure through opening 206 and then apply the swarm lure to an interior portion of the swarm box by rubbing the exposed swarm lure along the interior portion of the swarm trap to create a 1-4 inch dollop of the swarm lure formulation. While a 1-4 inch dollop is described herein, this disclosure is not limited to any particular size dollop. Rather, any size dollop appropriate to effectively attract honey bees is considered, included dollops less than 1 inch and dollops greater than 4 inches. Further, the swarm lure may also be applied along the opening of the swami trap. Any unused portion of the swami lure may be stored in a cool dry place or in a refrigerator for a subsequent use.

While the invention has been illustrated and described in detail in the drawings and foregoing description, the same is to be considered as illustrative and not restrictive in character, it being understood that only the preferred embodiments have been shown and described and that all changes, alternatives, modifications and equivalents that come within the spirit of the inventions are desired to be protected. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. While the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method actions, processes, and operations described herein are not to be construed as necessarily requiring their performance in the particular order discussed or illustrated, unless specifically identified as an order of performance. It is also to be understood that additional or alternative actions or operations may be employed. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A swarm lure formulation, comprising:
a tincture of queen bee;
a waxy carrier; and
an emulsifier;
wherein said tincture of queen bee and said emulsifier are dispersed in said wax.

2. The formulation of claim 1 wherein the tincture of queen bee comprises a first pheromone extracted from at least one virgin queen bee and a second pheromone extracted from at least one mated and laying queen bee.

3. The formulation of claim 1 wherein the waxy carrier comprises beeswax.

4. The formulation of claim 1 wherein the emulsifier comprises polysorbate 80.

5. The formulation of claim 1, further comprising at least one additional ingredient selected from the group consisting of a plant terpenoid and lemon grass oil.

6. The formulation of claim 1, further comprising at least one member selected from the group consisting of a lemon grass oil, a citral and a geraniol.

7. The formulation of claim 1, further comprising a lemon grass oil, a citral and a geraniol.

8. The formulation of claim 7, wherein the formulation comprises tincture of queen bee in an amount from about 2% to about 6% by weight of the formulation; a biodegradable wax carrier in an amount of from about 58% to about 82% by weight of the formulation; an emulsifier in an amount of from about 1% to about 6%, by weight of the formulation; a citral in an amount of from about 5% to about 10% by weight of the formulation; a geraniol in an amount of from about 5% to about 10% by weight of the formulation; and a lemon grass oil in an amount of from about 5% to about 10% by weight of the formulation.

9. A method for making a swami lure product, comprising:
heating a first quantity of a waxy carrier to a melting point temperature of the waxy carrier to provide a molten wax carrier;
mixing into the molten wax carrier an emulsifier, a tincture of queen bee and optionally additional ingredients to form a liquid swarm lure formulation;
loading the liquid swarm lure formulation into a dispenser;
cooling the liquid swarm lure formulation to form a solidified swarm lure formulation; and
sealing the dispenser with a cap.

10. The method of claim 9 wherein the tincture of queen bee comprises a first pheromone extracted from at least one virgin queen bee and a second pheromone extracted from at least one mated and laying queen bee.

11. The method of claim 9 wherein the waxy carrier comprises beeswax.

12. The method of claim 9 wherein the emulsifier comprises polysorbate 80.

13. The method of claim 9, further comprising mixing into the molten wax carrier at least one additional ingredient selected from the group consisting of a plant terpenoid and lemon grass oil.

14. The method of claim 9, further comprising mixing into the molten wax carrier at least one member selected from the group consisting of a lemon grass oil, a citral and a geraniol.

15. The method of claim 9, further comprising mixing into the molten wax carrier a lemon grass oil, a citral and a geraniol.

16. The method of claim 15, wherein the formulation comprises tincture of queen bee in an amount from about 2% to about 6% by weight of the formulation; a biodegradable wax carrier in an amount of from about 58% to about 82% by weight of the formulation; an emulsifier in an amount of from about 1% to about 6%, by weight of the formulation; a citral in an amount of from about 5% to about 10% by weight of the formulation; a geraniol in an amount of from about 5% to about 10% by weight of the formulation; and a lemon grass oil in an amount of fr©m about 5% to about 10% by weight of the formulation.

17. The method of claim 9 wherein the dispenser comprises a cylindrical tube and an axially movable component that selectively repositions the solidified swarm lure formulation relative to an opening formed in the cylindrical tube.

18. The method of claim 9 wherein the dispenser comprises a squeezable tube with an opening, the dispenser operable to dispense the solidified swarm lure formulation through the opening.

19. A method of luring honey bees to a swarm trap, comprising:
providing a swarm lure formulation including a tincture of queen bee, a waxy carrier and an emulsifier, wherein the tincture of queen bee and the emulsifier are dispersed in the waxy carrier; and
depositing a quantity of the swarm lure formulation onto the swarm trap.

20. The method of luring honey bees to a swami trap of claim 19 wherein the swarm lure formulation is contained within a dispenser that comprises a cylindrical tube and an axially movable component that selectively repositions the solidified swarm lure formulation relative to an opening formed in the cylindrical tube.

21. The method of luring honey bees to a swami trap of claim 20, wherein the axially movable component is repositionable by rotating a rotatable component of the dispenser.
